(19) United States
(12) Patent Application Publication
(10) Pub. No.: US 2026/0327100 A1
(43) Pub. Date: Oct. 22, 2026

(54) METHOD FOR REMOVING WATER BODY POLLUTANT BY ELECTRICALLY ACTIVATING SULFITE

(71) Applicant: INNOVATION CENTER OF YANGTZE RIVER DELTA, ZHEJIANG UNIVERSITY, JIAXING CITY, Zhejiang Province (CN)

(72) Inventors: YAN ZHANG, JIAXING CITY, ZHEJIANG PROVINCE (CN); YAN JIA, HANGZHOU CITY, ZHEJIANG PROVINCE (CN); TUQIAO ZHANG, JIAXING CITY, ZHEJIANG PROVINCE (CN); ZEKUN DONG, HANGZHOU CITY, ZHEJIANG PROVINCE (CN); YU TANG, HANGZHOU CITY, ZHEJIANG PROVINCE (CN)

(21) Appl. No.: 18/993,573

(22) PCT Filed: May 17, 2024
(86) PCT No.: PCT/CN2024/093785

§ 371 Date: Jan. 12, 2025

(30) Foreign Application Priority Data
Oct. 23, 2023 (CN) 202311381038.3

(51) Int. Cl. C02F 1/467; C02F 1/461; C02F 101/12; C02F 101/30; C02F 103/00

(52) U.S. Cl. CPC C02F 1/4672; C02F 1/46109; C02F 2001/46133; C02F 2101/12; C02F 2101/305; C02F 2103/007; C02F 2201/4614; C02F 2209/06; C02F 2209/44

(57) ABSTRACT

The present disclosure discloses a method for removing a water body pollutant by electrically activating a sulfite. The method includes: adding a sulfite solution into a water body containing a pollutant, then introducing direct current, and stirring continuously to remove an organic pollutant and/or an inorganic pollutant in the water body. By utilizing the method, the organic pollutant and/or the inorganic pollutant in the water body can be removed as required.

### FIELD OF TECHNOLOGY

The present disclosure belongs to the technical field of water body pollution remediation, and specifically relates to a method for removing a water body pollutant by electrically activating a sulfite.

### BACKGROUND TECHNOLOGY

With the development of economy and the progress of society, a wide variety of novel pollutants in water bodies have been frequently detected, which seriously threaten human health. On the one hand, organic pollutants, such as environmental endocrine disruptors, medicaments and personal care products, pesticides, etc., have relatively high toxicity and relatively strong environmental persistence, and are difficult to remove by traditional water disposal processes. On the other hand, inorganic pollutants, such as bromates, chlorites, heavy metal ions, etc., have relatively strong mutagenicity and carcinogenicity. In addition, with the development of industry, the phenomenon of combined pollution of water bodies has become increasingly common. For example, water bodies after oxidation or disinfection have combined pollution of organic pollutants and halogenated byproducts, such as chlorites, bromates, etc. ; industrial wastewater in electroplating, smelting, leather, printing and dyeing, pharmaceuticals and the like has combined pollution of hexavalent chromium and organic pollutants; and flue gas desulfurization wastewater has combined pollution of sulfites, heavy metal ions and organic pollutants.

An advanced oxidation technology can effectively oxidize and mineralize organic pollutants that are difficult to degrade due to the production of free radicals with ultra-strong oxidability in a reaction process. Reducing active substances produced by an advanced reduction technology can effectively achieve reduction and dehalogenation, and have relatively high removal efficiency for inorganic pollutants. Although the above advanced oxidation technology and advanced reduction technology have a relatively high oxidation or reduction removal rate for single pollutants, a variety of pollutants in water bodies with combined pollution are difficult to remove simultaneously.

Therefore, research and development of a novel technology that can not only oxidize organic pollutants but also reduce inorganic pollutants are more in line with the increasingly severe water pollution status. An activated sulfite technology can produce oxidizing and reducing active substances simultaneously, such that it can be used as both an advanced oxidation process and an advanced reduction process, and has a good application prospect in the technical field of water body pollution remediation.

When the activated sulfite is used as an advanced oxidation process, oxidizing active substances (SO₄⋅⁻, SO₅⋅⁻, HO⋅) produced by circulation of sulfur and oxygen free radicals can effectively oxidize and mineralize organic substances. Compared with persulfites, sulfites have the advantages of lower toxicity and price and no production of halogenated byproducts.

When the activated sulfite is used as an advanced reduction process, reducing active substances including SO₃⋅⁻, eaq- and H⋅ produced thereby can effectively achieve reduction and dehalogenation.

The concentration of oxygen is the key to distinguish an advanced sulfite reduction process and an advanced oxidation process. Traditional sulfite activation technologies (ultraviolet activation, transition metal ion activation, high-valence oxygen-containing metal salt activation, thermal activation) require additional introduction of oxygen when being used as advanced oxidation processes; and require to control a strict oxygen-free environment when being used as advanced reduction processes. In general, the technologies can only be unidirectionally applied to oxidation or reduction, and cannot be synchronously applied to oxidation and reduction to remove a variety of pollutants. In addition, energy consumption of the ultraviolet activation and thermal activation is relatively large, and metal toxicity caused by metal ions introduced by the transition metal ion activation and high-valence oxygen-containing metal salt activation may cause secondary pollution.

### SUMMARY OF THE INVENTION

The present disclosure provides a method for removing a water body pollutant by electrically activating a sulfite. By utilizing the method, an organic pollutant and/or an inorganic pollutant in a water body can be removed as required.

The present disclosure provides a method for removing a water body pollutant by electrically activating a sulfite. The method includes: adding a sulfite solution into a water body containing a pollutant, then introducing direct current, and stirring continuously to remove an organic pollutant and/or an inorganic pollutant in the water body.

Further, when a current of the introduced direct current is 100-300 mA and a concentration of the sulfite solution is 2-4 mM, a rate of removing the organic pollutant in the water body is 0.031-0.17 min⁻¹.

Under the condition of introducing an appropriate magnitude of the current and an appropriate concentration of the sulfite solution, a rate of electrochemically oxidizing the sulfite and a rate of producing oxygen reach a balance, a production rate of SO₄⋅⁻ is relatively high, and a rate of oxidizing the organic pollutant is relatively high. Therefore, a main purpose of the process is to remove the organic pollutant. When the concentration of the sulfite solution is too high, an oxygen evolution rate is relatively low, a conversion rate of sulfur and oxygen free radicals is relatively low, and the production rate of SO₄⋅⁻ is relatively low. On the other hand, too much sulfite will quench SO₄⋅⁻, such that oxidation efficiency of the organic pollutant is greatly reduced.

Further preferably, before the sulfite solution is added into the water body containing the pollutant, a pH of the water body containing the pollutant is adjusted to be higher than 7. In an electric field environment, the organic pollutant can be better oxidized to be removed under alkaline conditions, and the pH of the water body is regulated by adding an inorganic base. Under alkaline conditions, a rate of producing SO₃⋅⁻ by electrically activating the sulfite (formula (1)) is higher than a rate of producing HSO₃⋅ (formula (2)) under acidic conditions. In addition, an evolution potential of oxygen is relatively low, a production rate of oxygen (formula (3)) is higher than that under acidic conditions (formula (4)), and a conversion rate of sulfur and oxygen free radicals (formulas (5-13)) is relatively high. Therefore, a production rate of SO₄⋅⁻ (formula (11)) and a production rate of HO⋅ (formula (13)) are relatively high.

SO₃²⁻-e⁻%43 SO₃⋅⁻ (E(SO₃⋅⁻/SO₃²⁻=0.63V) (1)

HSO₃⁻-e⁻→HSO₃⋅ (E(HSO₃⋅/HSO₃⁻=0.84V) (2)

4OH⁻-4e⁻→O₂+2H₂O (E(O₂/OH⁻=0.401V) (3)

2H₂O-4e⁻→O₂+4H⁺ (E(O₂/OH⁻=1.229V) (4)

SO₃⋅⁻-e⁻+2OH⁻%43 SO₄²⁻+H₂O (K_{SO3⋅-}=4.38cm/s) (5)

HSO₃⋅e⁻+H₂O→SO₄²⁻+3H⁺ (K_{HSO3⋅}=2.83cm/s) (6)

SO₃⋅⁻+O₂→SO₅⋅⁻ (k=2.5×10⁹ M⁻¹s⁻¹) (7)

HSO₃⋅+O₂→HSO₅⋅ (k=1.1×10⁹ M⁻¹s⁻¹) (8)

SO₅⋅⁻+SO₃²⁻→SO₃⋅^{-+SO}₅²⁻ (k=1.0×10⁸ M⁻¹s⁻¹) (9)

HSO₅⋅+HSO₃⁻→HSO₃⋅+HSO₅⁻ (k=3.0×10⁷ M⁻¹s⁻¹) (10)

SO₅⋅⁻+SO₃²⁻→SO₄⋅⁻+SO₄²⁻ (k=5.0×10⁸ M⁻¹s⁻¹) (11)

HSO₅⋅+HSO₃⋅→SO₄⋅+SO₄²⁻+2H⁺ (k=6.0×10⁷ M⁻¹s⁻¹) (12)

SO₄⋅⁻+OH⁻→SO₄²⁻+OH⋅ (k=6.0×10⁷ M⁻¹s^{31 1}) (13)

Further, when a current of the introduced direct current is 20-40 mA and a concentration of the sulfite solution is 2-6 mM, a rate of removing the inorganic pollutant in the water body is 0.023-0.12 min⁻¹.

Under the condition of introducing an appropriate magnitude of the current and an appropriate concentration of the sulfite solution, an electrode reaction mainly includes oxidizing the sulfite, an oxygen evolution reaction is almost completely suppressed, a concentration of HSO₃⋅/SO₃⋅⁻ is relatively high, and a rate of reducing the inorganic pollutant is relatively high. Therefore, a main purpose of the process is to remove the inorganic pollutant. In addition, energy consumption is relatively low. When the concentration of the sulfite solution is too high, the production rate of HSO₃⋅/SO₃⋅⁻ is not obviously increased, because a factor limiting the production rate of HSO₃⋅/SO₃⋅⁻ at this time is current density.

Further preferably, before the sulfite solution is added into the water body containing the pollutant, a pH of the water body containing the pollutant is adjusted to be lower than 6.5. In an electric field environment, the inorganic pollutant can be better reduced to be removed under acidic conditions, and the pH of the water body can be regulated by adding an inorganic acid. Under acidic conditions, the production rate of oxygen is relatively low (formula (4)). In addition, an electrochemical oxidation rate of HSO3. (formula (6)) and an oxidation rate of oxygen (formula (8)) are both lower than an electrochemical oxidation rate of SO₃⋅⁻ (formula (5)) and an oxidation rate of oxygen (formula (7)). Therefore, the concentration of HSO₃⋅ is higher under acidic conditions, and the reduction rate of the inorganic pollutant is higher.

Further, when a current of the introduced direct current is 60-100 mA and a concentration of the sulfite solution is 2-4 mM, a rate of removing the organic pollutant in the water body is 0.015 min⁻¹-0.028 min⁻¹, and a rate of removing the inorganic pollutant in the water body is 0.019 min⁻¹-0.077 min⁻¹.

By introducing an appropriate magnitude of the current and an appropriate concentration of the sulfite solution, low concentrations of reducing free radicals and oxidizing free radicals simultaneously exist in the system, such that the reducing free radicals and the oxidizing free radicals reach a balance, and the effect of synchronous oxidation and reduction can be achieved. Further preferably, before the sulfite solution is added into the water body containing the pollutant, a pH of the water body containing the pollutant is adjusted to 6-9. Under neutral conditions, the concentration of the sulfite is equivalent to that of a bisulfite in the water body (formula (14)), such that synchronous oxidation of the organic pollutant and reduction of the inorganic pollutant can be achieved. When the water body is too acidic or too alkaline, a balanced state between the sulfite and the concentration of the sulfite will be destroyed, such that the oxidation rate of the organic pollutant is too low or the reduction rate of the inorganic pollutant is too low.

SO₃²⁻+H⁺→HSO₃⁻ (pKa=7.18) (14)

Further, a rate of the stirring is 400-800 rpm. By adopting an appropriate stirring rate, the reducing free radicals and the oxidizing free radicals can better undergo mass transfer to an electrode, such that an oxidation and/or reduction reaction can be better carried out.

Further, the organic pollutant includes any one or more of antibiotics, pesticides, and endocrine disruptors. Further, the organic pollutant is any one or more of carbamazepine, bisphenol A, metronidazole, propranolol, and atrazine.

Further, the inorganic pollutant is any one or more of chlorites, chlorates, bromates, and dichromates.

Further, the sulfite is sodium sulfite. An electrolyte solution used in the electrically activated sulfite system includes sodium sulfate and sodium sulfite. When the concentration of sulfate in the water body disposed by the method is limited, addition of an additional sodium sulfate electrolyte is not required.

Further, the direct current is introduced to the water body containing the pollutant by inserting a cathode and an anode into the water body containing the pollutant to form an electrochemical reactor, and the cathode and the anode are each a titanium-based ruthenium-iridium mixed metal oxide electrode. A sulfite oxidation potential and an oxygen evolution potential of the electrode are both relatively low, and electricity consumption is relatively low.

Principle of the present disclosure: The sulfite loses one electron in the anode and is oxidized to generate sulfite free radicals (formulas (1-2)), and an oxygen evolution reaction (formulas (3-4)) is carried out at the same time.

Under anoxic conditions, HSO₃⋅/SO₃⋅⁻ (E⁰=−2.47 V) produced by electrically activating the sulfite is used to reduce the inorganic pollutant.

Under aerobic conditions, SO₄⋅⁻ (formulas (11-12)) (E⁰=2.5-3.1 V) and HO⋅ (formula (13)) (E⁰=2.8 V) produced by the conversion reaction of sulfur and oxygen free radicals are used to oxidize the novel organic pollutant.

Compared with the prior art, the present disclosure has the following beneficial effects.
(1) When the electrically activated sulfite system is used as an advanced oxidation method to remove the organic pollutant, the generation of halogenated intermediate products can be avoided, and a major drawback of an advanced oxidation process is overcome.
(2) When the electrically activated sulfite system is used as an advanced reduction method to reduce the inorganic pollutant, the applied current density is relatively low, and the electricity consumption is relatively low.
(3) When the electrically activated sulfite system removes the novel pollutant in the water body, the remaining sulfite is easily oxidized in the anode to generate non-toxic sulfate, which will not cause secondary pollution to the water body.
(4) By controlling the concentrations of different sulfur and oxygen free radicals, the electrically activated sulfite system can achieve synchronous oxidation and reduction to remove a variety of pollutants, which is more in line with the increasingly severe water pollution status. For example, after disinfection by chlorine and chlorine dioxide, the electrically activated sulfite system is applied to efficiently oxidizing a novel chlorine-resistant pollutant while removing disinfection byproducts such as chlorites and remaining chlorine dioxide.

### BRIEF DESCRIPTION OF THE DRAWINGS

FIG. 1 shows concentration and time fitting curves during degradation of carbamazepine by an electrically activated sulfite system provided in Example 1;

FIG. 2 shows oxidation fitting curves of sulfites provided in Example 1 and Comparative Example 1;

FIG. 3 shows concentration and time fitting curves of bromates and bromine ions during degradation of the bromates by electrically activated sulfite systems provided in Example 2 and Comparative Example 2; and

FIG. 4 shows concentration and time fitting curves of a chlorite, chloride ions and carbamazepine during degradation of the chlorite and carbamazepine by an electrically activated sulfite system provided in Example 3.

### DESCRIPTION OF THE EMBODIMENTS

The present disclosure is further described in detail below in combination with specific examples, but the scope of protection of the present disclosure is not limited to the contents.

### EXAMPLE 1

An electrically activated sulfite system provided in Example 1 was used for oxidative degradation of carbamazepine in the following specific steps.

First, sodium sulfate with a concentration of 10 mM was added into a reactor, then a 5 μM carbamazepine solution was added into the reactor, and a pH value of a water body to be disposed was adjusted to 9 with diluted sodium hydroxide and sulfuric acid. Then, a 2 mM sodium sulfite solution with a pH adjusted to 9 in advance was added into the water body to reach a total system volume of 100 ml. Two 2×4 cm titanium-based ruthenium-iridium oxide electrodes were selected to serve as a cathode and an anode, respectively, and the two electrodes (at a spacing of 1.5 cm) were immersed in 100 mL of an electrolyte solution to form a single-chamber electrolytic cell. A constant current was set to 240 mA (i.e., a current density was 150 A/m²) by using a DC regulated power supply, and a reaction temperature was adjusted to 25° C. by using a water bath device. During a reaction, water samples were taken at different reaction time points to determine a residual concentration of the carbamazepine in the water body, and a degradation curve of the carbamazepine under different reaction time conditions was drawn.

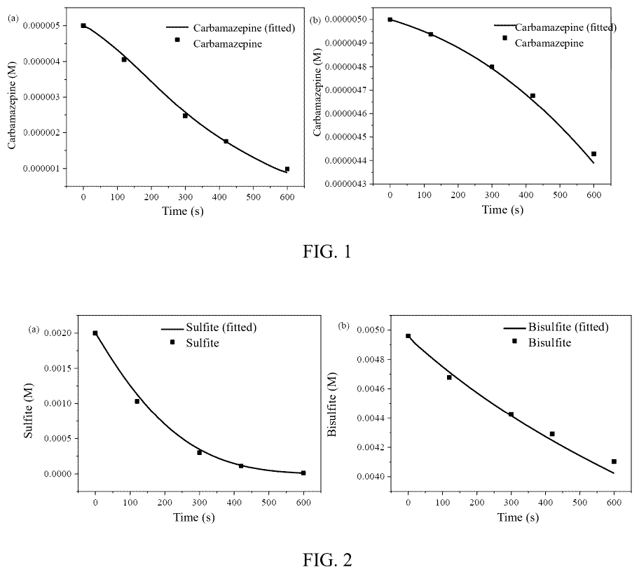

As can be seen from FIG. 1(a), a separate sulfite and electrochemical oxidation have extremely low removal efficiency for the carbamazepine, while the electrically activated sulfite system can effectively remove the carbamazepine. A removal rate of the carbamazepine reaches 80% or above within 10 min, while a sulfite (FIG. 2(a)) is completely oxidized into a sulfate. It is indicated that the electrically activated sulfite system can quickly degrade an organic pollutant and the generated sulfate will not cause secondary pollution to the water body.

### Comparative Example 1

An electrically activated sulfite system provided in Comparative Example 1 was used for oxidative degradation of carbamazepine in the following specific steps.

First, sodium sulfate with a concentration of 10 mM was added into a reactor, then a 5 uM carbamazepine solution was added into the reactor, and a pH value of a water body to be disposed was adjusted to 6 with diluted sodium hydroxide and sulfuric acid. Then, a 5 mM sodium bisulfite solution with a pH adjusted to 6 in advance was added into the water body to reach a total system volume of 100 ml. Two 2×4 cm titanium-based ruthenium-iridium oxide electrodes were selected to serve as a cathode and an anode, respectively, and the two electrodes (at a spacing of 1.5 cm) were immersed in 100 mL of an electrolyte solution to form a single-chamber electrolytic cell. A constant current was set to 60 mA (i.e., a current density was 37.5 A/m² ) by using a DC regulated power supply, and a reaction temperature was adjusted to 25° C. by using a water bath device. During a reaction, water samples were taken at different reaction time points to determine a residual concentration of the carbamazepine in the water body, and a degradation curve of the carbamazepine under different reaction time conditions was drawn.

As can be seen from FIG. 1(b), in the case of acidic conditions with the relatively low current density and the relatively high concentration of the bisulfite, a removal rate of the carbamazepine is only 12% within 10 min, which is far lower than that in Example 1. In addition, an oxidation rate of a sulfite is only 18% (FIG. 2(b)), which is far lower than that in Example 1. On the one hand, a production rate of HSO₃⋅ in an electrically activated bisulfite system is relatively low under acidic conditions. On the other hand, since the current density is relatively low at this time and the concentration of the bisulfite is too high, a product rate of oxygen is relatively low, a conversion rate of sulfur and oxygen free radicals is relatively low, and a production rate of SO₄⋅⁻ is relatively low. Therefore, an oxidation rate of the bisulfite and a degradation rate of an organic pollutant are both significantly lower than those in Example 1.

### EXAMPLE 2

An electrically activated sulfite system provided in Example 2 was used for reduction of a bromate in the following specific steps.

First, a 1 mg/L bromate solution was added into a reactor, and a pH value of a water body to be disposed was adjusted to 6 with diluted sodium hydroxide and sulfuric acid. Two 2×4 cm titanium-based ruthenium-iridium oxide electrodes were selected to serve as a cathode and an anode, respectively, and the two electrodes (at a spacing of 1.5 cm) were immersed in 100 mL of an electrolyte solution to form a single-chamber electrolytic cell. Then, a sodium bisulfite solution with a concentration of 2 mM and a pH adjusted to 6 in advance was added into the reactor to reach a total system volume of 100 ml. Then, direct current was applied to start a reduction reaction. A constant current was set to 30 mA (i.e., a current density was 18.75 A/m²) by using a DC regulated power supply, and a reaction temperature was adjusted to 25° C. by using a water bath device. During the reaction, water samples were taken at different reaction time points to determine a residual concentration of the bromate in the water body and a concentration of bromine ions generated by reduction, and a reduction curve of the bromate under different reaction time conditions was drawn.

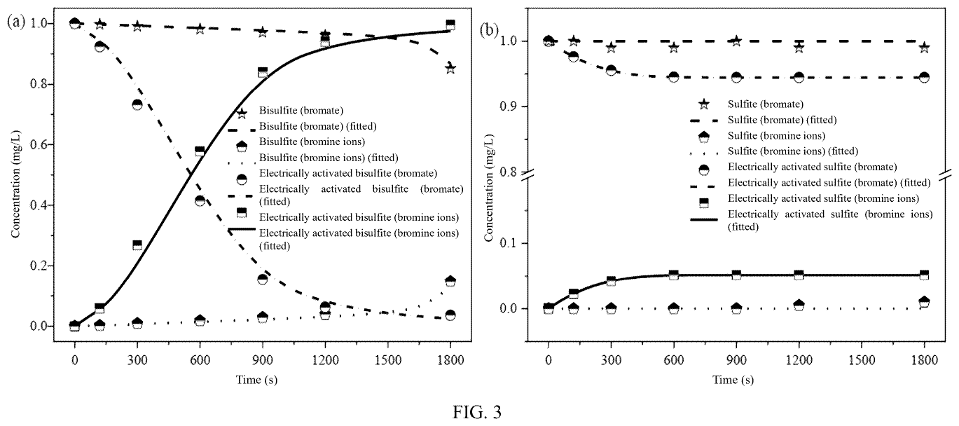

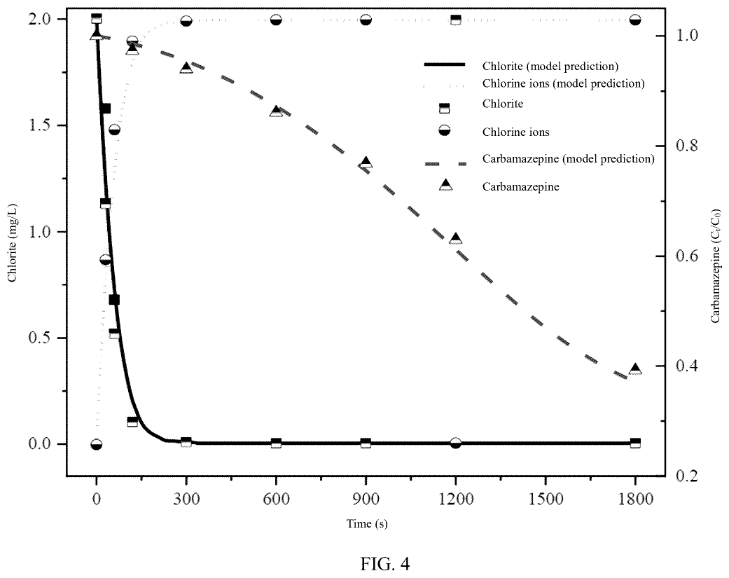

As can be seen from FIG. 3(a), compared with separate use of a bisulfite to reduce the bromate, the electrically activated sulfite system significantly increases a degradation rate of the bromate, the bromate is degraded by 99% or above within 30 min, and a residual concentration of the bromate is 7 ug/L, meeting limit value requirements (10 ug/L) of Standards for drinking water quality (GB5749-2022). When the method is used for reducing a bromate in a water body after pre-ozonation, reduction of the bromate can be achieved by using a sulfite and the bromate as an electrolyte without the need to add an additional electrolyte. The remaining sulfite can be removed by electrochemical oxidation, and a concentration of sulfate ions in the system is about 250 mg/L, meeting limit value requirements (250 mg/L) of Standards for drinking water quality (GB5749-2022).

### Comparative Example 2

An electrically activated sulfite system provided in Comparative Example 2 was used for reduction of a bromate in the following specific steps.

First, a 1 mg/L bromate solution was added into a reactor, and a pH value of a water body to be disposed was adjusted to 10 with diluted sodium hydroxide and sulfuric acid. Two 2×4 cm titanium-based ruthenium-iridium oxide electrodes were selected to serve as a cathode and an anode, respectively, and the two electrodes (at a spacing of 1.5 cm) were immersed in 100 ml of an electrolyte solution to form a single-chamber electrolytic cell. Then, a sodium bisulfite solution with a concentration of 1 mM and a pH adjusted to 10 in advance was added into the reactor to reach a total system volume of 100 ml. Then, direct current was applied to start a reduction reaction. A constant current was set to 60 mA (i.e., a current density was 37.5 A/m² ) by using a DC regulated power supply, and a reaction temperature was adjusted to 25° C. by using a water bath device. During the reaction, water samples were taken at different reaction time points to determine a residual concentration of the bromate in the water body and a concentration of bromine ions generated by reduction, and a reduction curve of the bromate under different reaction time conditions was drawn.

As can be seen from FIG. 3(b), in the case of alkaline conditions with the relatively high current density and the relatively low concentration of a sulfite, a removal rate of the bromate is only 5% within 30 min, which is far lower than that in Example 2. On the one hand, a production rate of SO₃⋅ in the electrically activated sulfite system is relatively low under alkaline conditions. On the other hand, since the current density is relatively high at this time and the concentration of a sulfite is too low, a product rate of oxygen is relatively high, and SO₃⋅ is almost completely captured by oxygen and cannot be used for reduction of the bromate.

### EXAMPLE 3

An electrically activated sulfite system provided in Example 3 was used for synchronous reduction of a chlorite and oxidation of carbamazepine in the following specific steps.

First, a chlorite solution with a concentration of 2 mg/L and a 2 uM carbamazepine solution were added into a reactor, and a pH value of a water body to be disposed was adjusted to 7 with diluted sodium hydroxide and sulfuric acid. Two 2×4 cm titanium-based ruthenium-iridium oxide electrodes were selected to serve as a cathode and an anode, respectively, and the two electrodes (at a spacing of 1.5 cm) were immersed in 100 mL of an electrolyte solution to form a single-chamber electrolytic cell. Then, a sodium sulfite solution with a concentration of 2 mM and a pH adjusted to 7 in advance was added into the reactor to reach a total system volume of 100 ml. Then, direct current was applied to start a reaction. A constant current was set to 60 mA (i.e., a current density was 37.5 A/m²) by using a DC regulated power supply, and a reaction temperature was adjusted to 25° C. by using a water bath device. During the reaction, water samples were taken at different reaction time points to determine a residual concentration of the chlorite in the water body, a concentration of chlorine ions generated by reduction and a residual concentration of the carbamazepine, and reduction curves of the chlorite and chlorine ions as well as a degradation curve of the carbamazepine under different reaction time conditions were drawn.

As can be seen from FIG. 4, with proceeding of the reaction, the electrically activated sulfite system has a gradually weakened reduction capacity and a gradually enhanced oxidation capacity. When the reaction is carried out for 5 min, the chlorite can be completely reduced into chloride ions, meeting limit value requirements (0.7 mg/L) of Standards for drinking water quality (GB5749-2022). When the reaction is carried out for 30 min, a removal rate of the carbamazepine reaches 63%. When micro-polluted source water or chlorine dioxide disinfection effluent is disposed, synchronous removal of disinfection byproducts, such as a chlorite, and novel chlorine dioxide-resistant organic pollutants can be achieved by using a sulfite and a chlorite as an electrolyte without the need to add an additional electrolyte. At this time, the sulfite is completely oxidized to generate a sulfate, and a concentration of sulfate ions in the system is about 250 mg/L, meeting limit value requirements (250 mg/L) of Standards for drinking water quality (GB5749-2022).

What is claimed is:

1. A method for removing a water body pollutant by electrically activating a sulfite, comprising: adding a sulfite solution into a water body containing a pollutant, then introducing direct current, and stirring continuously to remove an organic pollutant and/or an inorganic pollutant in the water body.

2. The method for removing a water body pollutant by electrically activating a sulfite according to claim 1, wherein when a current of the introduced direct current is 100-300 mA and a concentration of the sulfite solution is 2-4 mM, a rate of removing the organic pollutant in the water body is 0.031 min⁻¹-0.17 min⁻¹.

3. The method for removing a water body pollutant by electrically activating a sulfite according to claim 2, wherein before the sulfite solution is added into the water body containing the pollutant, a pH of the water body containing the pollutant is adjusted to be higher than 7.

4. The method for removing a water body pollutant by electrically activating a sulfite according to claim 1, wherein when a current of the introduced direct current is 20-40 mA and a concentration of the sulfite solution is 2-6 mM, a rate of removing the inorganic pollutant in the water body is 0.023min⁻¹-0.12 min⁻¹.

5. The method for removing a water body pollutant by electrically activating a sulfite according to claim 4, wherein before the sulfite solution is added into the water body containing the pollutant, a pH of the water body containing the pollutant is adjusted to be lower than 6.5.

6. The method for removing a water body pollutant by electrically activating a sulfite according to claim 1, wherein when a current of the introduced direct current is 60-100 mA and a concentration of the sulfite solution is 2-4 mM, a rate of removing the organic pollutant in the water body is 0.015 min⁻¹-0.028 min⁻¹, and a rate of removing the inorganic pollutant in the water body is 0.019 min⁻¹-0.077 min⁻¹.

7. The method for removing a water body pollutant by electrically activating a sulfite according to claim 6, wherein before the sulfite solution is added into the water body containing the pollutant, a pH of the water body containing the pollutant is adjusted to 6-9.

8. The method for removing a water body pollutant by electrically activating a sulfite according to claim 1, wherein a rate of the stirring is 400-800 rpm.

9. The method for removing a water body pollutant by electrically activating a sulfite according to claim 1, wherein the organic pollutant comprises any one or more of antibiotics, pesticides, and endocrine disruptors, and the inorganic pollutant is any one or more of chlorites, chlorates, bromates, and dichromates.

10. The method for removing a water body pollutant by electrically activating a sulfite according to claim 1, wherein the direct current is introduced to the water body containing the pollutant by inserting a cathode and an anode into the water body containing the pollutant to form an electrochemical reactor, and the cathode and the anode are each a titanium-based ruthenium-iridium mixed metal oxide electrode.
